(19) United States
(12) Patent Application Publication
(10) Pub. No.: US 2018/0308395 A1
(43) Pub. Date: Oct. 25, 2018

(54) Utility Marker assembly and method of the same

(71) Applicant: Stanley V. Kulkaski, Warren, NJ (US)

(72) Inventor: Stanley V. Kulkaski, Warren, NJ (US)

(21) Appl. No.: 15/492,441

(22) Filed: Apr. 20, 2017

(51) Int. Cl. G09F 3/00

(52) U.S. Cl. CPC G09F 3/00

(57) ABSTRACT

A utility marker for use on any sort of vertically suspended electrical wires or pipe to establish a visual awareness. The inventions comprises of an elongated tubular member of a relatively rigid plastic having a hollow interior throughout its length. The tubular member has a slit extending longitudinally thereof between opposite ends. This is to allow the tubular member to be in surrounding relationship by being moved laterally over the electrical wire or pipe with the hollow interior accessible through the slit. First and second generally diametrically opposed aligned apertures are located adjacent the first end of the tubular member. This is so that they can be aligned with the electrical wire or pipe. This allows the marker to be wrapped over the electrical wire or pipe in with applied pressure and twisting. The plug or fitting on the electrical wire or pipe serves as a stopping device for the utility marker; thus allowing the utility marker to be suspended longitudinally with the electrical wire or pipe.

### BACKGROUND OF THE INVENTION

The subject invention is directed towards marking and creating visual awareness of electrical wires and pipes suspended from ceilings, beams etc. The brightness and colors of the invention allow for identification of overhead hazards in a work place or similar location.

Electrical outlets, piping for air or water are commonly found in manufacturing facilities and create a hazard for workers that are unseen when using fork trucks; or similar equipment that can raise a machine to an elevation that can interfere with electrical cords, air and water lines suspended from a ceiling or similar overhead structure.

The utility marker consists of a tube with a slot extending longitudinally along its length with open apertures at opposite ends allowing an electrical cord or pipe to be contained within the hollow portion of the marker.

### BRIEF DESCRIPTIONS OF THE DRAWINGS

The above and other objects and advantages will become apparent from the following description when read in conjunction with the accompanying drawing wherein:

FIG. 1 is a front view of the utility guard where an electric cord is encased within the utility marker in an assembly formed in accordance with the subject invention;

FIG. 2 is a detailed isometric drawing showing use of the invention when used as an electric cord utility marker;

FIG. 3 is a detailed isometric drawing showing the use of the invention when used an air line utility marker;

FIG. 4 is a detailed isometric drawing showing the use of the invention when used a water line utility marker.

### SUMMARY OF THE INVENTION

The subject invention provides a utility marker and assembly and method of using the same which has a minimal number of parts and which can be installed rapidly without tools.

In accordance with one aspect of the invention, there is provided a electrical wire cord or air and water lines assembly combination that includes an elongated electrical wire or air/water pipe extending from a ceiling or overhead area between first and second spaced points with the electrical cord or air/water pipe terminating by a electrical plug or plumbing fitting. An elongated tubular plastic marker guard member that has a preformed slot along its length is positioned in surrounding relation to the electrical wire cord or air/water pipe to extend longitudinally thereof with a first end portion of the guard member encircling a portion of the electrical cord or air/water pipe and fully encircling the electrical wire cord or air/water pipe at the second point. Aligned openings are formed through diametrical points parallel on the same plane.

Accordingly, a primary object of the present invention is the provision of a utility marker assembly which is extremely simple to use and requires a minimum number of parts

A further object of the invention is a guard assembly of the type which can be rapidly installed by snapping the tubular member onto the electrical wire cord or air/water pipe assembly and without tools.

Another provision of a utility marker assembly incorporates two layers of material that encompasses the electrical wire cord, further decreasing the amount of UV light penetrating the inner tubular member of the utility marker assembly.

Yet another object of the utility marker assembly and the snap feature of the design is using a rigid plastic material such as homopolymer or copolymer material used in the process of manufacturing utility markers. The rigidity of the material is a key feature of the snap-back design which simplifies the installation of the tubular member to the electrical cord wire or air/water pipe by snapping the tubular member onto the electrical cord wire or air/water pipe.

Yet another object of the utility marker is use of flame retardant materials in the manufacturing process to prevent fires from electrical sources.

Furthermore, another object is the provision of a method of installing a utility marker to the electrical cord wire or air/water pipe that allows a single guard and fastener assembly to be used with a variety of different sizes of electrical cords and pipes.

1. A utility marker for use on electrical cords or pipe is having an end terminating in an electrical plug or pipe fitting, said utility marker consisting:

2. An elongated tubular member of a relatively rigid plastic having a hollow interior throughout its length and terminating in the second open opposite ends, said tubular member having a single slot extending longitudinally thereof between opposite ends to allow the tubular member to be installed in surrounding relationship to the electrical wire or pipe.

3. First and second general diametrically openings on the same plane adjacent to the first and second end of the tubular member.

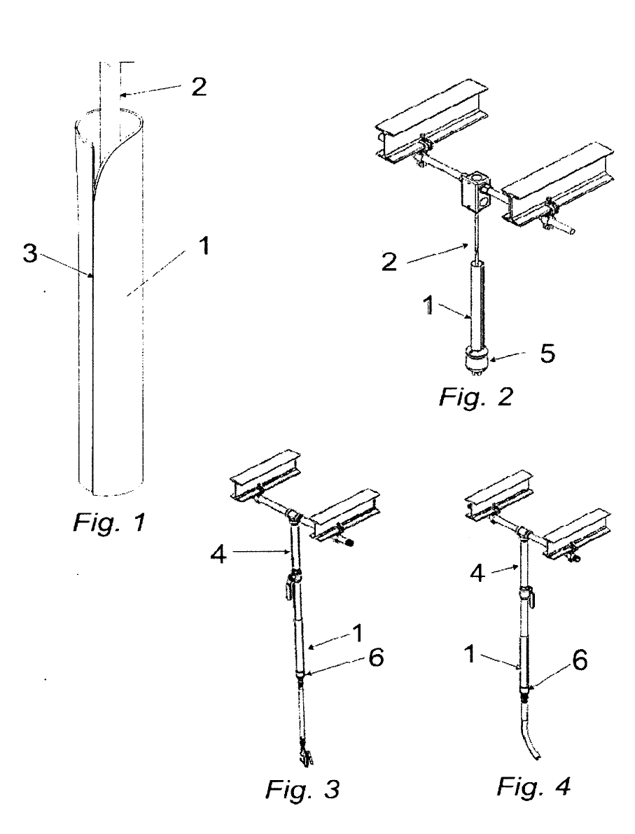

1. Referring more to the particular to the drawings wherein the showings are for the purpose of illustrating preferred and alternate embodiments of the invention only, and not for the purpose of limiting same, FIG. 1 show a utility marker 1 provided with a general electrical wire 2 or pipe 4 having a utility marker formed in accordance with the preferred embodiment of the invention connected thereto. The electrical cord 2 or pipe 4 is of typical construction and extends vertically in a relationship with the electrical cord FIG. 2 air pipe FIG. 3 water pipe with the first upper portion having no terminator and the first lower portion terminating by a electrical plug 5 or pipe fitting or hose 6 can be formed merely by twisting the utility marker 1 around the electrical cord 2 or pipe 4 into a surround relationship with the cord 2 or pipe 4.

2. The arrangement and construction of the utility marker 1 can best be understood by the reference FIG. 2 through FIG. 4. As shown therein, the utility marker 1 is primarily constructed of an elongated tubular member 1 which is preferably formed from a suitably relatively rigid section of plastic tubing. Many different plastics could be used including homopolymer and copolymer plastics having the necessary strength and rigidity to perform the necessary marker function. The tubular member 1 has a longitudinally slot 3 (see FIG. 1) that extends throughout the length of the tube from the exterior to the hollow interior. Normally, with extruded plastic of the type considered for use herein, the formation of the slot 3 takes place during the extrusion process and remains open after being extruded and cooled. The internal stresses cause the edges of the slot 3 to form an overlap circumferentially into a nearly sealed relationship. In any event the diameter of tube 1 is such to allow it to fully circle and contain the electrical cord 2 or pipe 4.

3. In order to maintain the utility marker 1 in the proper assembled position on the electrical cord 2 or pipe 4 and to retain it against undesirable movement or removal, the utility marker 1 is terminated by an electrical plug 5 or pipe fitting 6.

4. A desirable aspect of the invention is the preferred design for tool less installation and can be understood by FIG. 1
As can be appreciated, the entire installation and affixing of the utility marker to the electrical cord or pipe can take place rapidly without the use of tools.
